(19) United States
(12) Patent Application Publication
(10) Pub. No.: US 2011/0216530 A1
(43) Pub. Date: Sep. 8, 2011

(54) Solar Power Illuminated Book

(76) Inventor: David J. Arnold, Greenvale, NY (US)

(21) Appl. No.: 12/871,530

(22) Filed: Aug. 30, 2010

Related U.S. Application Data
(60) Provisional application No. 61/237,931, filed on Aug. 28, 2009.

(51) Int. Cl. F21L 4/08; F21L 4/00

(52) U.S. Cl. 362/183; 362/157

(57) ABSTRACT

A solar powered self-illuminating book comprising a first cover having an outer surface and an inner surface; a second cover, wherein the first and second covers are positionable in a closed orientation in which the second cover is opposed to the first cover; one or more pages connected between the first and second cover; one or more solar panels disposed in the outer surface of the first cover and exposed to the environment, a rechargeable battery electrically connected to each of the one or more solar panels; and one or more LED's embedded within the one or more pages which are electrically connected to the rechargeable battery.

### FIELD OF THE INVENTION

The present invention relates to the field of books. More particularly, the present invention relates to a solar powered illumination book.

### BACKGROUND OF THE INVENTION

It is typically necessary to use an overhead light or a lamp to provide the requisite illumination when reading a book at night or in the dark. However, when reading a book to children before bedtime, leaving the light on may disturb the process for falling asleep. This is problematic because children often associate light with activity and darkness with sleep. Other options, such as using a flashlight, can be unwieldy when trying to hold the flashlight with one hand and hold the book with the other.

While other self-illuminating books exist, these books include exposed light sources and are powered by a single external power source, such as batteries. Accordingly, there is a need for a self-illuminated book having an integral light source that illuminates each page and which requires no outside power source.

### SUMMARY OF THE INVENTION

According to one embodiment, a solar powered self-illuminating book comprises a first cover having a outer and inner surface; a second cover, wherein the first and second covers are positionable in a closed orientation in which the second cover is opposed to the first cover; one or more pages connected between the first and second cover; one or more solar panels disposed in the outer surface of the first cover and exposed to the environment; a rechargeable battery electrically connected to each of the one or more solar panels; and one or more LED's embedded within the one or more pages which are electrically connected to the rechargeable battery.

According to another embodiment, a solar powered self-illuminating book comprises a first cover; a second cover; a spine connecting the first and second covers, wherein the first and second covers are positionable in a closed orientation in which the second cover is opposed to the first cover; one or more pages connected to the spine between the first and second covers; one or more solar panels disposed in an outer surface of the spine and exposed to the environment; a rechargeable battery electrically connected to each of the one or more solar panels; and one or more LED's embedded within the one or more pages which are electrically connected to the rechargeable battery.

According to another embodiment, a solar powered self-illuminating book comprises a first cover; a second cover, wherein the first and second covers are positionable in a closed orientation in which the second cover is opposed to the first cover; one or more solar panels disposed in the outer surface of the first cover and exposed to the environment; a rechargeable battery electrically connected to each of the one or more solar panels; and one or more LED's embedded within at least one of the first and second covers which are electrically connected to the rechargeable battery.

These and other features of this invention are described in, or are apparent from, the following detailed description of various exemplary embodiments of this invention.

### BRIEF DESCRIPTION OF THE DRAWINGS

Exemplary embodiments of this invention will be described with reference to the accompanying figures.

FIG. 1 is a front, perspective view of a solar powered self-illuminating book according to an exemplary embodiment of the present invention.

FIG. 2 is a front view of the front cover of the closed book of FIG. 1.

FIG. 3 is a front, perspective view of the book of FIG. 1 open to the first page and displaying exposed circuitry of the book.

FIG. 4. is a front, perspective view of the book of FIG. 1 open to a particular page displaying the LED's being illuminated through the page

FIG. 5. is a front, perspective view of the book of FIG. 1 open to the last page.

FIG. 6. is a rear view of the closed book of FIG. 1.

FIG. 7. is a top view of the closed book of FIG. 1.

FIG. 8 is a front, perspective view of a solar powered self-illuminating book according to another exemplary embodiment of the present invention.

FIG. 9 is a front, perspective view of a solar powered self-illuminating book according to another exemplary embodiment of the present invention.

### DETAILED DESCRIPTION OF THE EXEMPLARY EMBODIMENTS

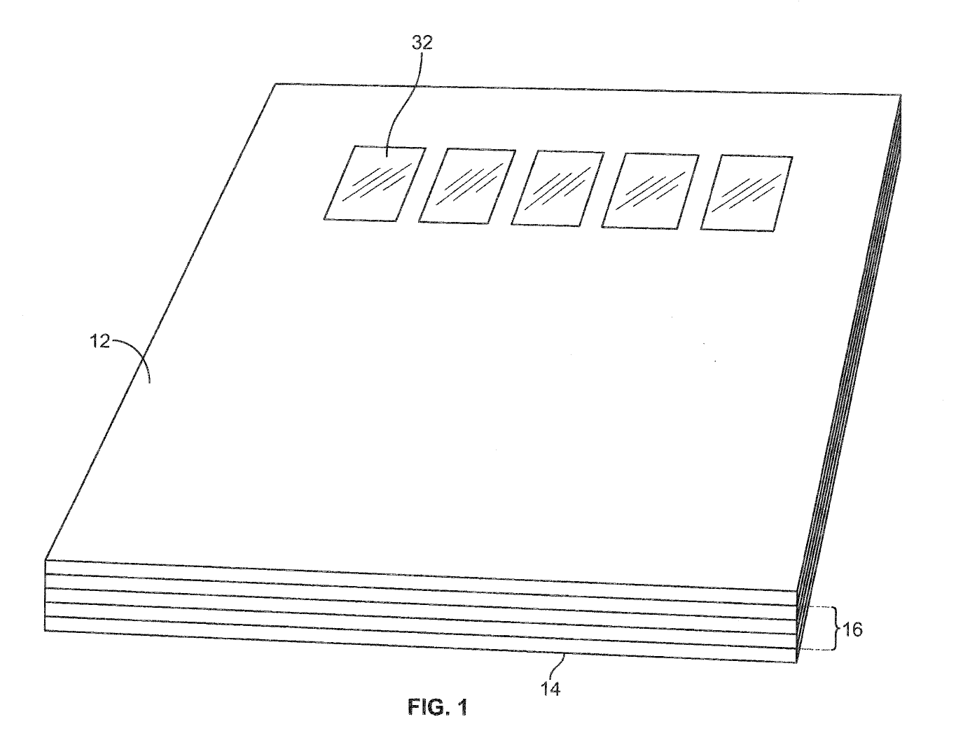

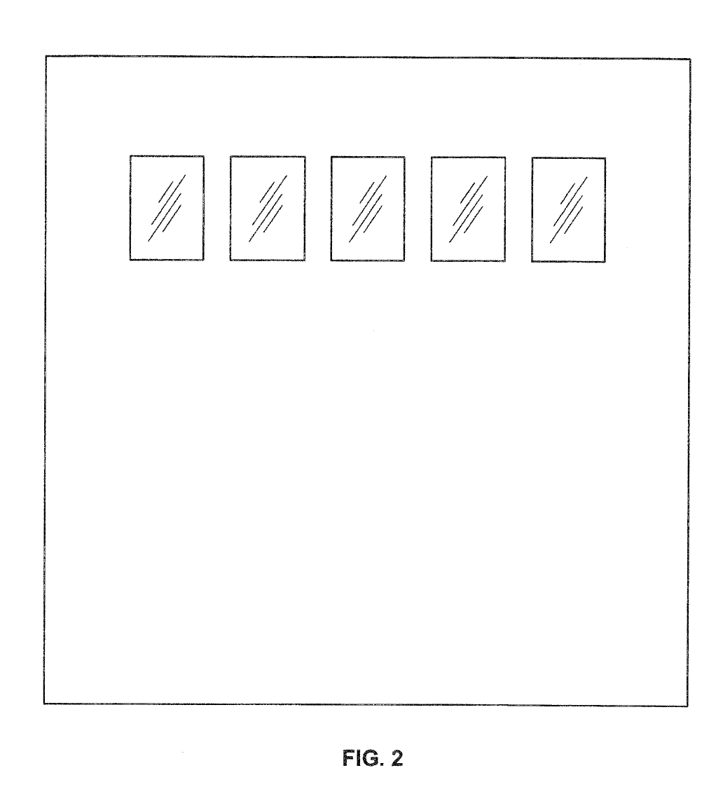

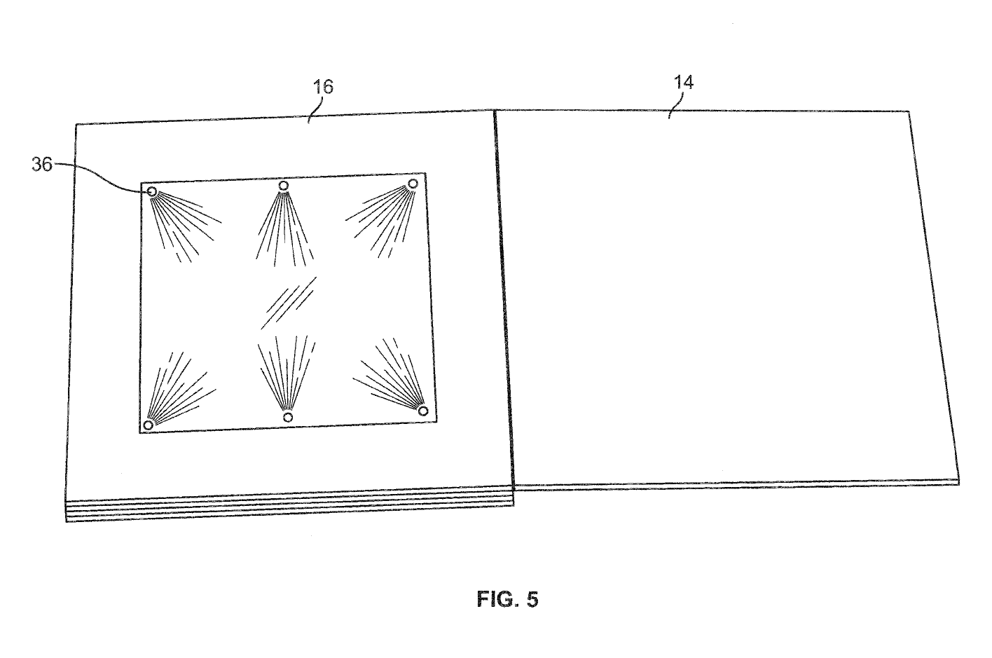

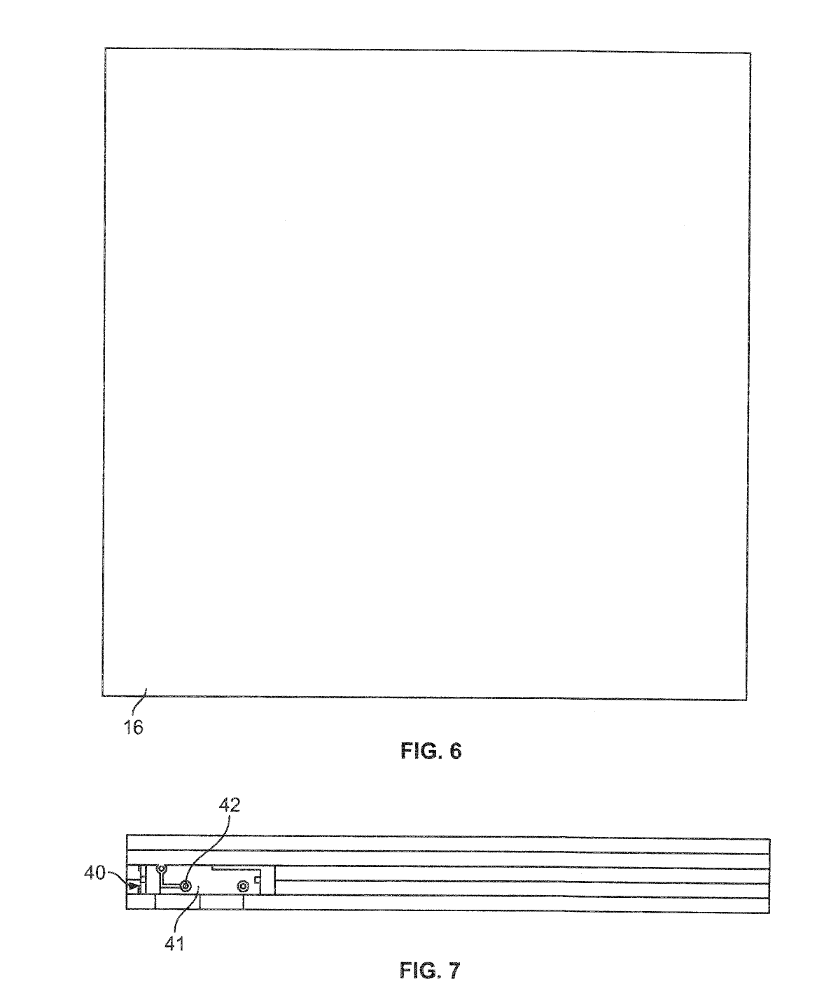

FIGS. 1-9 illustrate a solar powered self-illuminating book according to exemplary embodiments of the present invention.

The book comprises a front cover 12, a back cover 14, a plurality of pages 16, and one or more solar modules 30. Each solar module 30 comprises a solar panel 32 exposed to the environment to collect light, in a known matter, a rechargeable battery 34 electrically connected to the solar panel 32, and one or more LED's 36 disposed on one of the pages 16 or covers 12, 14 and electrically connected to the battery 34.

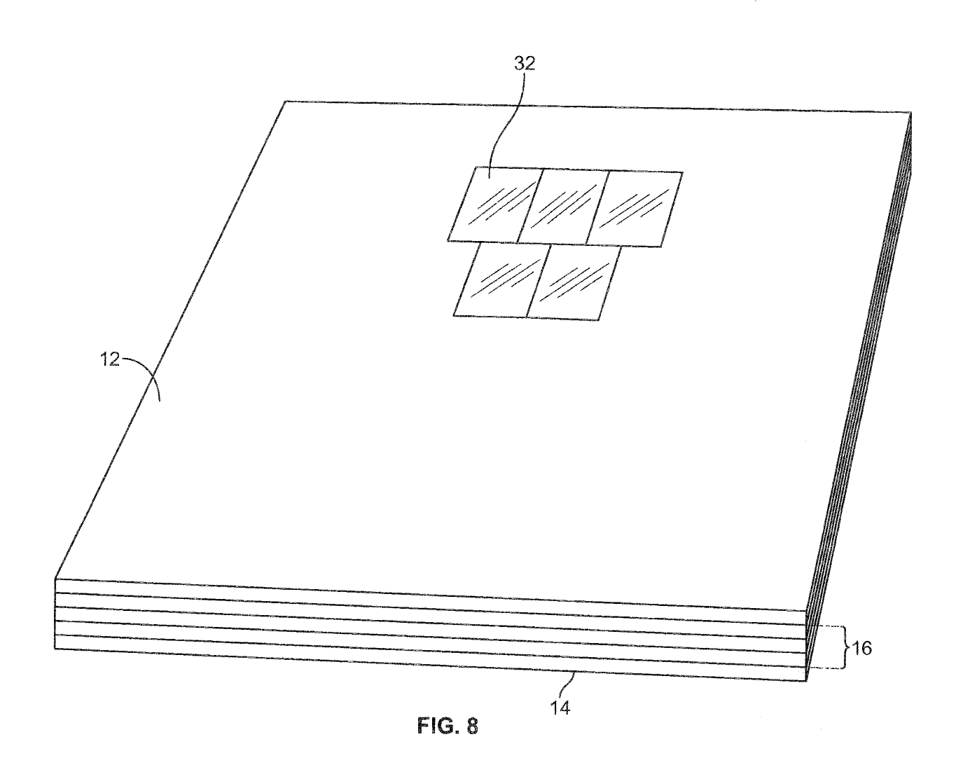

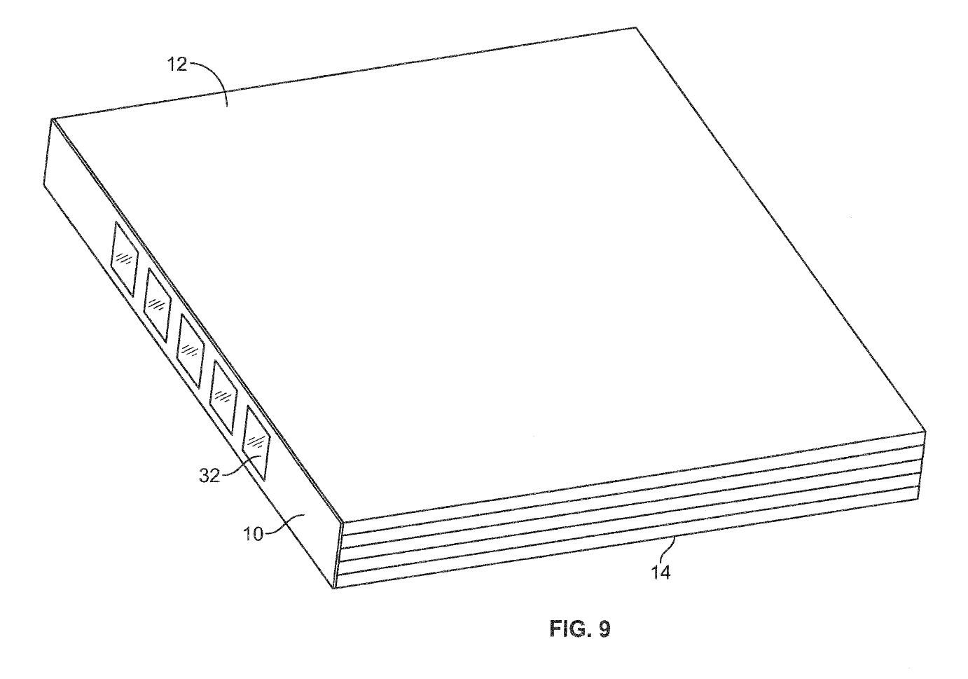

In one embodiment as shown by FIG. 1, the solar panels 32 may be embedded in the a cover 12, 14 of the book. The solar panels 32 may be arranged in a variety of patterns, for example, as shown by FIGS. 1 and 8. In other embodiments, such as shown by FIG. 9, the solar panels 32 may be embedded in various other location on the book, such as along spine 10. Of course, the solar panels may be placed in other areas and/or in different orientations and are not limited by these exemplary embodiments.

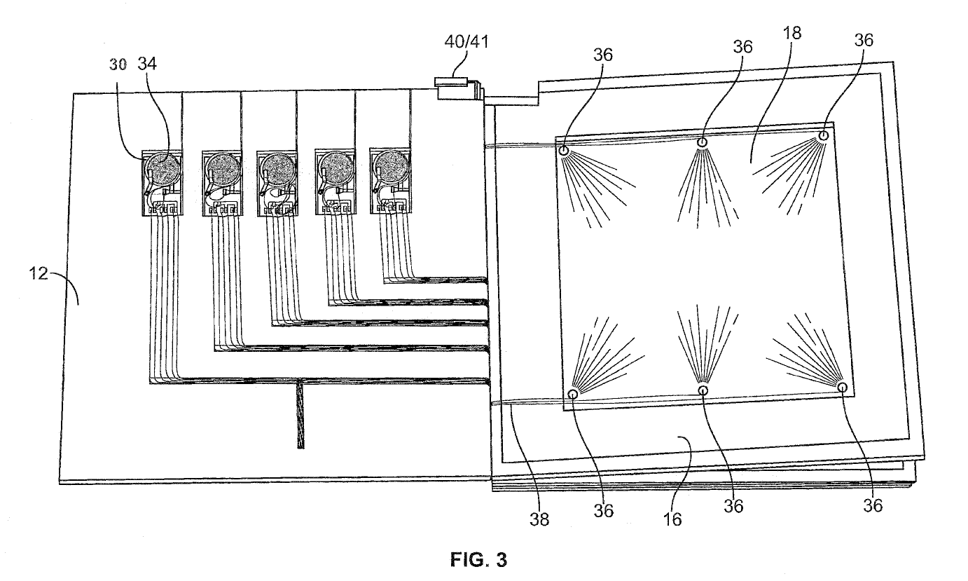

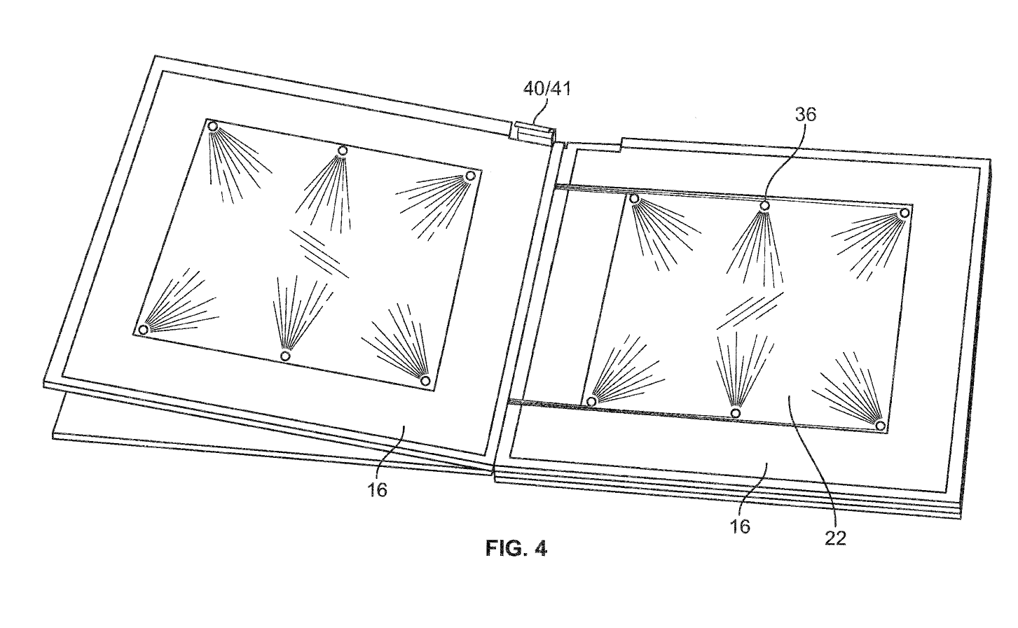

Referring to FIGS. 3-4, the battery 34 is electrically connected to each of the one or more LED's 36 in a solar module 30 by wires 38. The battery 34 may connect to each of the one or more LED's 36 located on a single page 16 as shown, however the battery 34 may also connect to LED's 16 located on two or more different pages 16. The battery 34 and wires 38 may be embedded within one or both covers 12, 14 and/or pages 16, and may be covered so as to be visually concealed.

In one embodiment such as shown by FIGS. 3-5, a cavity 18 may be formed in the pages 16 within which the LED's 36 are disposed. Alternatively, a plurality of cavities 18 may be formed on each page 16 within which one or more of the LED's 36 are disposed. The cavities 18 may extend entirely through the page so that the LED's 36 can illuminate both sides of the page. The cavities 18 may be covered by a transparent cover 22 that hides the LED's 36 but which allows the light emitted by the LED's 36 to illuminate the page 16. The transparent cover 22 may diffuse the light emitted by LED's 36 to provide a softer light. For example, the transparent cover 22 may be a light diffusing paper, plastic, or the like.

In another embodiment, the LED's 36 may be embedded in one or both covers 12, 14 of the book. For example, the LED's 36 may be located around or near the edges of the one or more covers 12, 14. An attachment device, for example, pockets, clips, straps, or the like, may be provided the inside surfaces of covers 12, 14 for securing an existing book between the covers 12, 14, such as for use as a slip cover. An attachment device may also be provided on the spine 10 for permanently or releasably securing pages 16 between the covers 12, 14, such as for use as a binder, scrapbook, photo album, or the like.

In another embodiment, rather than being embedded with the covers 12, 14 or pages 16, the LED's 36 may be attached to an outer surface of the pages 16 or the inside surface of one or both covers 12, 14.

The front cover 12, back cover 14, and pages 16 may be comprised of a material that provides a thickness sufficient to allow the LED's 36 and wires 38 to be embedded therein. For example, the front cover 12, back cover 14, and pages 16 may be comprised of a material such as cardboard, foam board, and the like. However, other thinner materials, such as paper, may also be used for the pages 16 if the LED's and wires 38 are not embedded therein.

Referring to FIGS. 3-4 and 7, the book may include a toggle switch 40 for turning the LED's 36 on and off. The toggle switch 40 may be comprised of opposing connections 41 and 42 located on the front and back covers 12, 14, respectively. When the book is closed, the toggle switch 40 opens the circuit to turn off LED's. When the book is opened, the toggle switch 40 completes the circuit to turn on the LED's and illuminate the pages 16.

Now that embodiments of the present invention have been shown and described in detail, various modifications and improvements thereon will become readily apparent to those skilled in the art. Accordingly, the exemplary embodiments of the invention, as set forth above, are intended to be illustrative, not limiting. The spirit and scope of the present invention is to be construed broadly and limited only by the appended claims, and not by the foregoing specification.

What is claimed is:

1. A solar-powered book comprising:
a first cover having a first outer surface and a first inner surface;
a second cover having a second outer surface and a second inner surface;
a plurality of pages positioned in between the first cover and the second cover;
at least one solar module comprising a solar panel;
a battery electrically coupled to the solar panel; and
at least one light emitting diode electrically coupled to the battery.

2. The solar-powered book of claim 1 further comprising a spine, the spine having a third outer surface and a third inner surface, the spine permanently or releasably securing the plurality of pages between the first cover and the second cover, wherein the solar panel is disposed in the third outer surface of the spine and is environmentally exposed to collect light.

3. The solar-powered book of claim 1, wherein the battery is electrically coupled to the solar panel by wires and the at least one light emitting diode is electrically coupled to the battery located one at least one page of the plurality of pages.

4. The solar-powered book of claim 1 further comprising a cavity wherein the at least one light emitting diode is disposed in the cavity.

5. The solar-powered book of claim 4, wherein the cavity is covered by a transparent cover that at least partially conceals light emitted from the at least one light emitting diode and allows the emitted light to illuminate the page.

6. The solar-powered book of claim 1, wherein the at least one light emitting diode is at least one of:
embedded within the first cover;
embedded within the second cover;
embedded within a page of the plurality of pages;
attached to the first outer surface;
attached to the second outer surface;
attached to the first inner surface; and
attached to the second inner surface.

7. The solar-powered book of claim 1, wherein the solar panel is disposed in the first outer surface of the first cover.

8. The solar-powered book of claim 1, wherein the solar panel is disposed in the second outer surface of the second cover.

9. The solar-powered book of claim 1 further comprising a toggle switch electrically coupled to the at least one light emitting diode, the toggle switch being adapted to be in positions to turn the at least one light emitting diode on and off, the toggle switch comprising opposed connections located on the front cover and the back cover, respectively, whereby:
in a closed position, wherein the first cover and second cover are substantially parallel to each other thereby preventing the plurality of pages from being exposed, the toggle switch is adapted to be in the second position; and
in an open position, wherein at least two pages of the plurality of pages are exposed, the toggle switch is adapted to be in the first position.

10. A solar powered, illuminated system comprising:
a solar module comprising a solar panel adapted to be environmentally exposed to a source of light to collect energy;
a rechargeable battery electrically coupled to the solar panel, the rechargeable battery adapted to store the collected energy and being adapted to store additional energy when at least part of the collected energy is depleted;
at least one light emitting diode electrically coupled to the battery adapted to receive energy converted by the rechargeable battery; and
a toggle switch electrically coupled to the at least one light emitting diode, the toggle adapted to be in positions to control the at least one light emitting diode, wherein when the toggle switch is in a first position, a circuit controlling the at least one light emitting diode is in an open position and when the toggle switch is in a second position, the circuit is in a closed position.

11. The solar powered, illuminated system of claim 10 further comprising a plurality of light emitting diodes wherein the plurality of light emitting diodes are adapted to emit light when the toggle switch is in the second position and wherein the plurality of light emitting diodes are not adapted to emit light when the toggle switch is in the first position.

12. The solar powered, illuminated system of claim 10, wherein the rechargeable battery automatically recharges by collecting energy from the solar panel.

13. The solar powered, illuminated system of claim 12, wherein the plurality of light emitting diodes are selectively controlled to emit light or to not emit light.

14. A method of illuminating a solar-powered book including the steps of:
collecting light energy in a solar module having a solar panel;
transmitting energy to a rechargeable battery coupled to the solar panel, wherein when a certain amount of energy is provided to the rechargeable battery, the rechargeable battery being adapted to control at least one light emitting diode, the at least one light emitting diode being positioned in a cavity and being coupled to the rechargeable battery, to emit light to illuminate the solar-powered book when the solar-powered book is an open orientation.
